(19) United States
(12) Patent Application Publication
(10) Pub. No.: US 2024/0395040 A1
(43) Pub. Date: Nov. 28, 2024

(54) Method, System, and Apparatus for Controlling Multiple Experimental Devices

(71) Applicant: SHIMADZU CORPORATION

(72) Inventor: Risa NIMURA, Kyoto-shi (JP)

(21) Appl. No.: 18/695,402

(22) PCT Filed: Jun. 24, 2022
(86) PCT No.: PCT/JP2022/025305

§ 371 Date: Mar. 26, 2024

(30) Foreign Application Priority Data
Sep. 27, 2021 (JP) 2021-156770

(51) Int. Cl. G06V 20/40; G01N 35/00; H04N 5/783

(52) U.S. Cl. CPC G06V 20/46; G01N 35/00722; H04N 5/783; G01N 2035/0091

(57) ABSTRACT

Whether an experimental protocol executed by a plurality of experimental devices is executed as expected, can be confirmed. A method for controlling a plurality of experimental devices comprises: controlling the plurality of experimental devices based on an experimental protocol in which an order of processing operations is defined; obtaining a motion video such that processing of an analyte in a first experimental device and transportation of the analyte from the first experimental device to a second experimental device can be viewed in a synchronized manner through the motion video, the first and second experimental devices belonging to the plurality of experimental devices; and displaying the motion video.

### TECHNICAL FIELD

The present invention relates to a method, system, and apparatus for controlling a plurality of experimental devices.

### BACKGROUND ART

A conventionally known apparatus controls an experimental device. For example, Japanese Patent Laying-Open No. 2004-3173220 (PTL 1) discloses a controller to control an automated dispensing device. The controller allows how the automated dispensing device is operated to be virtually displayed to enable confirmation of whether a process of operation of the automated dispensing device operates correctly as expected.

### CITATION LIST

### Patent Literature

PTL 1: Japanese Patent Laying-Open No. 2004-317320

### SUMMARY OF INVENTION

### Technical Problem

A single experimental protocol may be performed by a plurality of experimental devices. In such a case, in order to confirm whether the experimental protocol is executed as intended by the designer of the experimental protocol, it is necessary to confirm an operation of an experimental device that executes some processing operation, and in addition thereto, confirm cooperation between an experimental device that executes preceding one of two consecutive processing operations and an experimental device that executes a processing operation subsequent thereto. However, the controller of the automated dispensing device disclosed in PTL 1 does not provide consideration for confirmation of cooperation between the automated dispensing device and other experimental devices. For example, when a sample container to be analyzed is passed between a plurality of devices, an expected result cannot be obtained if timing of a processing operation such as injection of a reagent and incubation in each step of the experimental protocol and timing of passing the sample container do not match, whereas the timing of passing and that of a processing operation cannot be confirmed simply from a simulation result of whether a sample or a reagent is present in the sample container.

The present invention has been made to address such an issue, and contemplates confirmation of whether an experimental protocol executed by a plurality of experimental devices is executed as expected.

### Solution to Problem

According to one aspect of the present invention, a method comprises the steps of: controlling a plurality of experimental devices based on an experimental protocol in which an order of processing operations is defined; obtaining a motion video such that processing of an analyte in a first experimental device and transportation of the analyte from the first experimental device to a second experimental device can be viewed in a synchronized manner through the motion video, the first and second experimental devices belonging to the plurality of experimental devices; and displaying the motion video.

According to another aspect of the present invention a system comprises a plurality of experimental devices, a controller, at least one imaging device, and a terminal device. The controller controls the plurality of experimental devices based on an experimental protocol in which an order of processing operations is defined. The at least one imaging device obtains a motion video such that processing of an analyte in a first experimental device and transportation of the analyte from the first experimental device to a second experimental device can be viewed in a synchronized manner through the motion video, the first and second experimental devices belonging to the plurality of experimental devices. The terminal device displays the motion video.

According to another aspect of the present invention an apparatus comprises a storage unit, a display unit, and a control unit. The storage unit stores a simulation program. The control unit executes the simulation program to control a plurality of experimental devices, based on an experimental protocol in which an order of processing operations is defined, the plurality of experimental devices being designed in a virtual space, and to cause the display unit to display a motion video such that processing of an analyte in a first experimental device and transportation of the analyte from the first experimental device to a second experimental device can be viewed in a synchronized manner through the motion video, the first and second experimental devices belonging to the plurality of experimental devices.

### Advantageous Effects of Invention

The method, system, and apparatus of the present invention allows a motion video to be displayed such that processing of an analyte in a first experimental device and transportation of the analyte from the first experimental device to a second experimental device can be viewed in a synchronized manner through the motion video, the first and second experimental devices belonging to a plurality of experimental devices, to allow confirmation of whether an experimental protocol executed by the plurality of experimental devices is executed as expected.

### BRIEF DESCRIPTION OF DRAWINGS

FIG. 1 is a block diagram showing a configuration of an automated experimental system according to a first embodiment.

FIG. 2 is a block diagram showing a hardware configuration of a terminal device of FIG. 1.

FIG. 3 is a diagram showing a GUI configuration of an example of an experimental protocol designed in an experimental protocol management program of FIG. 1.

FIG. 4 is a diagram showing an example of a GUI configuration of the experimental protocol management program of FIG. 1 displaying a motion video showing the experimental protocol of FIG. 3 on trial.

FIG. 5 is a diagram showing another example of the GUI configuration of the experimental protocol management program of FIG. 1 displaying a motion video showing the experimental protocol of FIG. 3 on trial.

FIG. 6 is a block diagram showing an example of a hardware configuration of a controller of FIG. 1.

FIG. 7 is a flowchart showing an example of a flow of a process executed in the automated experimental system of FIG. 1.

FIG. 8 is a block diagram showing a configuration of an information processing device according to a second embodiment;

FIG. 9 is a diagram showing a plurality of experimental devices designed in a virtual space by an experimental protocol simulation program of FIG. 8.

FIG. 10 is a block diagram showing a hardware configuration of an information processing device of FIG. 8.

FIG. 11 is a flowchart showing an example of a flow of a simulated process of an experimental protocol performed by a computer of FIG. 8.

### DESCRIPTION OF EMBODIMENTS

Embodiments will now be described in detail with reference to the accompanying drawings. In the following description, identical or corresponding components shown in the figures are identically denoted and in principle will not be described repeatedly.

### First Embodiment

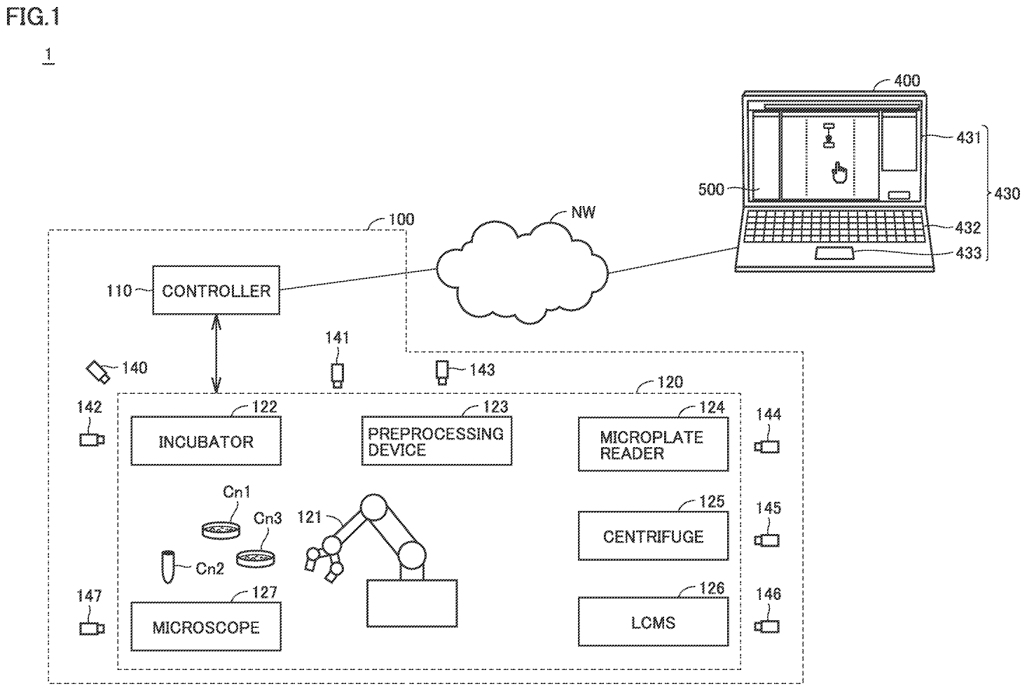

FIG. 1 is a block diagram showing a configuration of an automated experimental system 1 according to a first embodiment. As shown in FIG. 1, automated experimental system 1 comprises an experimental facility 100 and a terminal device 400. Terminal device 400 includes an input and output unit 430. Input and output unit 430 includes a display 431, a keyboard 432, and a touch pad 433. Terminal device 400 is, for example, a notebook computer, a personal computer, a smartphone, and a tablet. Experimental facility 100 and terminal device 400 are interconnected via a network NW. For example, network NW includes the Internet, a wide area network (WAN), or a local area network (LAN). Two or more terminal devices may be connected to network NW and there may be two or more automated experimental systems.

An experimental protocol management program 500 is installed in terminal device 400 in advance. Keyboard 432 and touch pad 433 receive a GUI operation done by a user to experimental protocol management program 500. That is, the user of terminal device 400 selects an automated experimental system in experimental protocol management program 500 by a GUI operation through keyboard 432 and touch pad 433, and designs an experimental protocol to be executed by the automated experimental system. The experimental protocol defines an order of processing operations executed by a plurality of experimental devices included in the automated experimental system selected by the user. Terminal device 400 sends the experimental protocol designed by the user to experimental facility 100.

Experimental facility 100 includes a controller 110, a plurality of experimental devices 120, and cameras 140, 141, 142, 143, 144, 145, 146, 147 (or at least one imaging device). Controller 110 controls the plurality of experiment devices 120 to automatically execute the experimental protocol received from terminal device 400. The plurality of experimental devices 120 includes a robot 121, an incubator 122, a preprocessing device 123, a microplate reader 124, a centrifuge 125, a liquid chromatograph mass spectrometer (LCMS) 126, and a microscope 127.

Robot 121 follows the order of the processing operations that is defined in the experimental protocol to move a culture container Cn1 (e.g., a petri dish, a flask, or a well plate) containing a sample to an experimental device corresponding to each of the processing operations. Culture container Cn1 contains, for example, agar containing cultured cells (or an analyte). Incubator 122 incubates cells seeded in culture container Cn1 while performing temperature control. Preprocessing device 123 automatically distributes (dispenses) a fixed amount of sample to each of a plurality of microplates (or wells). Microplate reader 124 measures optical properties (e.g., absorbance and fluorescence intensity) of the sample in the microplate. Centrifuge 125 centrifugally separates a component of an analyte accommodated in a container Cn2. LCMS 126 separates an analyte accommodated in a container Cn3 for analysis (for example, a vial or a well plate) by a liquid chromatograph, and performs mass spectrometry to separate the separated analyte's components for each mass-to-charge ratio (m/z). Microscope 127 magnifies a small analyte (e.g., a cell) to allow the analyte to be observed with the naked eye.

When culture container Cn1 has its medium exchanged, a stock container or pipette tip containing a fresh medium is placed at a predetermined location within preprocessing device 123. Robot 121 unloads culture container Cn1 stored in incubator 122. Robot 121 transports culture container Cn1 to preprocessing device 123 and places the culture container at a designated location.

Preprocessing device 123 sucks and removes the medium from culture container Cn1 and washes culture container Cn1. Preprocessing device 123 dispenses fresh medium from the stock container into culture container Cn1. After dispensing by preprocessing device 123 is completed, robot 121 holds and transports culture container Cn1 to incubator 122.

When it is observed that the cells in culture container Cn1 grow, culture container Cn1 stored in incubator 122 is unloaded by robot 121. Robot 121 transports culture container Cn1 to microscope 127, and places culture container Cn1 on an observation stage of microscope 127. After having a focal length adjusted to focus on the cells to be observed, microscope 127 captures an image of the cells. After the imaging with microscope 127 is completed, robot 121 holds and transports culture container Cn1 to incubator 122.

When the medium for the cells in culture container Cn1 is analyzed, a container Cn3 for analysis, a container Cn2 for centrifugation, a standard sample, a protein removing organic solvent, etc., are placed in preprocessing device 123 at predetermined locations. Robot 121 unloads culture container Cn1 stored in incubator 122, transports it to preprocessing device 123, and places it at a designated location. After the organic solvent is dispensed into container Cn2, a culture solution is dispensed from culture container Cn1 into container Cn2. After the culture solution and the organic solvent are sufficiently agitated, robot 121 holds and transports container Cn2 to centrifuge 125. Centrifuge 125 rotates at a specified speed for a specified period of time. As a result, the liquid contained in container Cn2 is separated into a layer of the organic solvent and a layer of the culture solution. Subsequently, robot 121 holds and brings container Cn2 to preprocessing device 123 and places the container at a designated location. Preprocessing device 123 dispenses a supernatant of the medium separated in container Cn2 into container Cn3 for analysis, and subsequently dispenses the standard sample into container Cn3 at the same location as the supernatant of the medium. Robot 121 transports container Cn3 from preprocessing device 123 to LCMS 126 and stores the container in LCMS 126. LCMS 126 starts an automated analysis of a substance contained in container Cn3 according to a condition previously designated for analysis.

Camera 140 captures an image of an overview of the plurality of experimental devices 120, and outputs a motion video (a first motion video) including the overview of the plurality of experimental devices 120 to controller 110. Camera 141 captures an image of robot 121 and outputs a motion video (a second motion video) including robot 121 to controller 110. Camera 142 captures an image of incubator 122 and outputs a motion video (the second motion video) including incubator 122 to controller 110. Camera 143 captures an image of preprocessing device 123 and outputs a motion video (the second motion video) including preprocessing device 123 to controller 110. Camera 144 captures an image of microplate reader 124 and outputs a motion video (the second motion video) including microplate reader 124 to controller 110. Camera 145 captures an image of centrifuge 125 and outputs a motion video (the second motion video) including centrifuge 125 to controller 110. Camera 146 captures an image of LCMS 126 and outputs a motion video (the second motion video) including LCMS 126 to controller 110. Camera 147 captures an image of microscope 127, and outputs a motion video (the second motion video) including microscope 127 to controller 110.

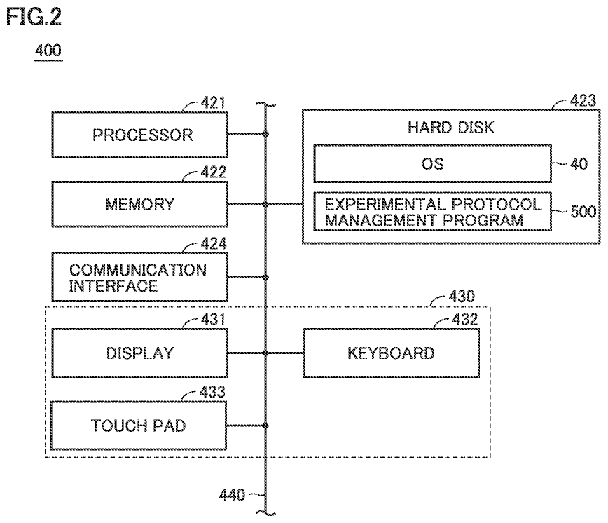

FIG. 2 is a block diagram showing a hardware configuration of terminal device 400 of FIG. 1. As illustrated in FIG. 2, terminal device 400 includes a processor 421, a memory 422 and a hard disk 423 as a storage, a communication interface 424, and input and output unit 430. These are communicably interconnected through a bus 440.

Hard disk 423 is a non-volatile storage device. Hard disk 423 stores, for example, an operating system (OS) program 40 and experimental protocol management program 500. Other than data in FIG. 2, for example, settings and outputs of a variety of types of applications are stored in hard disk 423. Memory 422 is a volatile storage device and includes a dynamic random access memory (DRAM) for example.

Processor 421 includes a central processing unit (CPU). Processor 421 reads a program stored in hard disk 423 into memory 422 and executes the program. Processor 421 is connected to network NW through communication interface 424.

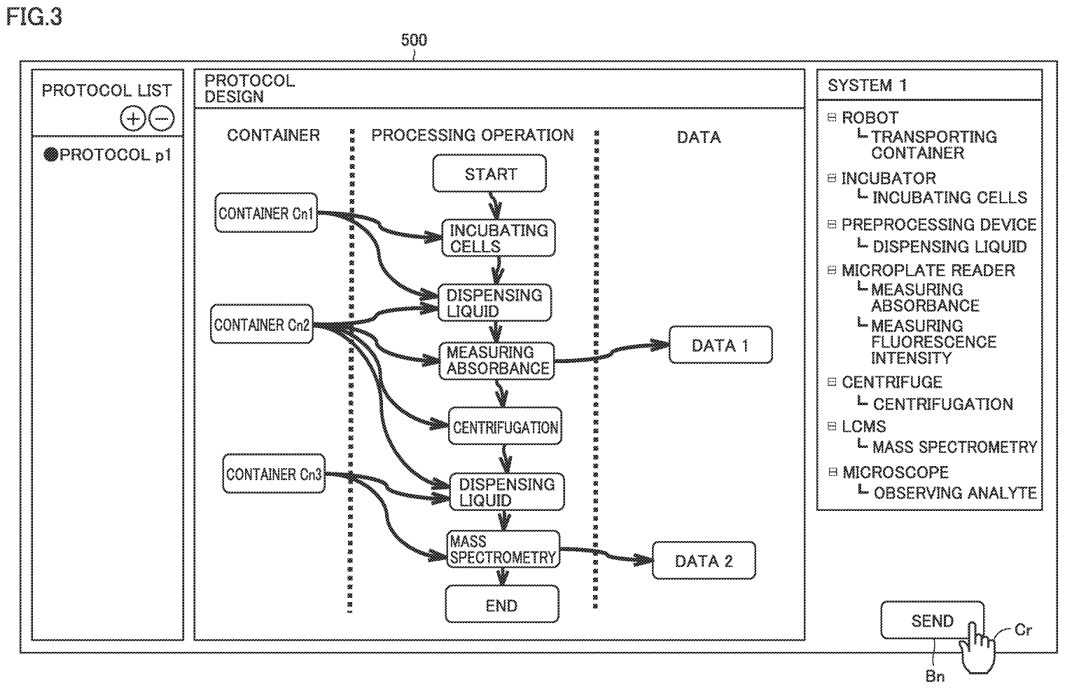

FIG. 3 is a diagram showing a GUI configuration of an example of experimental protocol p1 designed in experimental protocol management program 500 of FIG. 1. As shown in FIG. 3, experimental protocol p1 includes culturing cells, dispensing liquid, measuring absorbance, centrifugation, dispensing liquid, and mass spectrometry as processing operations. The processing operations are executed in the order of culturing cells, dispensing liquid, measuring absorbance, centrifugation, dispensing liquid, and mass spectrometry. When a send button Bn is pressed with a cursor Cr, experimental protocol p1 is sent to experimental facility 100. An experimental protocol which can be designed in experimental protocol management program 500 may include iteration and branching.

In a process for designing an experimental protocol by experimental protocol management program 500, a variety of settings can be made for each of processing operations. In the process for designing the experimental protocol, when an erroneous setting is done so that it is impossible to execute a processing operation by an experimental device (e.g., when a container which is not designated is referred to in the process), the erroneous setting can be found in a debugging (or compiling) operation in which a formal consistency of the experimental protocol, that is, whether processing operations included in the experimental protocol are each executable, is determined. However, when an erroneous setting is done such that while it is possible to execute a processing operation by an experimental device the processing operation provides an erroneous result (e.g. when, of a plurality of containers (or reagents) designated in the experimental protocol, an erroneous container is designated as an input for the processing operation), a formal consistency is recognized in the experimental protocol, and the erroneous setting cannot be found by debugging.

Furthermore, an experimental condition for the experimental protocol (for example, a condition necessary for cooperation of the plurality of experimental devices) can be set in accordance with an experimental environment of automated experimental system 1 and the performance of each of the plurality of experimental devices 120. It is difficult for the designer of the experimental protocol (or a user of terminal device 400) to actually reproduce the same experimental environment as automated experimental system 1 and an experimental device equivalent to each of the plurality of experimental devices 120. Therefore, it is difficult for the designer of the experimental protocol to confirm appropriateness of the experimental condition set in the experimental protocol in an environment other than automated experimental system 1. If the experimental protocol is executed based on an inappropriate experimental condition, unnecessary cost and time are spent on an experiment based on the experimental protocol.

Accordingly, in automated experimental system 1, how an experimental protocol is being tried by the plurality of experiment devices 120 is captured as a motion video such that processing of an analyte in a first one of the plurality of experiment devices 120 and transportation of the analyte from the first experimental device to a second one of the experimental devices can be viewed in a synchronized manner through the motion video, and the motion video is sent to terminal device 400. The user of terminal device 400 can confirm from a location remote from experimental facility 100 that the experimental condition of the experimental protocol is appropriate and the plurality of experimental devices operate in cooperation. It should be noted that the user may confirm whether the plurality of experimental devices operate in cooperation by viewing the motion video after the protocol is effected, rather than in real time. In that case, the user can confirm it at a desired time by designating reproduction of the motion video stored in terminal device 400. It is suitable that the motion video stored in terminal device 400 be stored in association with information of an experimental protocol corresponding thereto. This facilitates recognizing and reproducing a motion video that is desired by the user from a plurality of motion videos for confirming the protocol stored in terminal device 400. The motion video may be stored not only in terminal device 400 but also in a server computer (not shown).

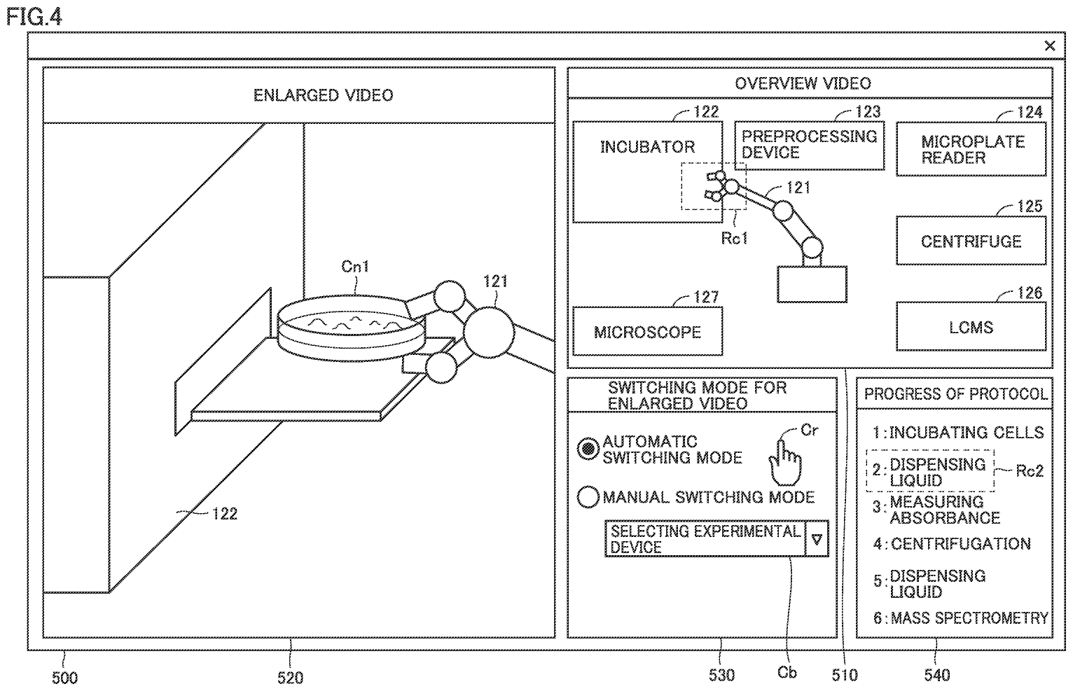

FIG. 4 is a diagram showing an example of a GUI configuration of experimental protocol management program 500 of FIG. 1 displaying a motion video showing experimental protocol p1 of FIG. 3 on trial. As shown in FIG. 4, experimental protocol management program 500 includes a window 510 showing a video of an overview, a window 520 showing an enlarged video, a window 530 indicating a switching mode for the enlarged video, and a window 540 indicating how experimental protocol p1 proceeds. It may not be terminal device 400 that receives from controller 110 the motion video showing the experimental protocol tried by the plurality of experiment devices 120. That is, a device used to design an experimental protocol may be different from a device caused to reproduce a motion video.

Also referring to FIG. 1, window 510 displays a motion video captured by camera 140 of FIG. 1. In window 510, at least one experimental device that executes a processing operation based on an experimental protocol sent from terminal device 400 is highlighted. Window 520 displays a motion video (a specific motion video) captured by any one of cameras 141 to 147. Windows 510 and 520 are juxtaposed. By observing windows 510 and 520 together, a general state of the plurality of experimental devices 121 to 127 controlled based on experimental protocol p1 and a specific state of a processing operation being executed can be collectively grasped.

Window 530 indicates a switching mode for the motion video displayed in window 520. The switching mode includes an automatic switching mode and a manual switching mode. When the automatic switching mode is selected, a motion video displayed in window 520 is automatically switched to a motion video of a camera that captures an image of an experimental device involved in a processing operation being executed. When the manual switching mode is selected, a motion video displayed in window 520 is switched to a motion video of a camera that captures an image of an experimental device selected in a combo box Cb.

Window 540 indicates processing operations aligned in accordance with an order of the processing operations defined in the experimental protocol. Window 540 highlights the processing operation being executed. By referring to window 540, the processing operation being executed can be confirmed.

Window 520 of FIG. 4 displays a video obtained through the processing operations defined in experimental protocol p1 when “culturing cells” (or a first processing operation) ends and “dispensing a liquid” (or a second processing operation) starts. When the “culturing cells” ends and the “dispensing a liquid” starts, robot 121 holds culture container Cn1 in order to move culture container Cn1 (or an analyte) output from incubator 122 (or a first experimental device) to preprocessing device 123 (or a second experimental device) that performs “dispensing liquid”. By observing window 520, whether the analyte is smoothly passed between two consecutive processing operations in experimental protocol p1 can be confirmed. Generally, an analyte may change when the analyte is passed between two consecutive processing operations. For example, when there is a step of mixing two different reagents in the first processing operation, a single reagent that is the mixture of the two reagents is passed to the second processing operation. In this way, how a plurality of reagents are divided, integrated, and denatured through a series of protocol can also be easily confirmed in a motion video. While there is also a conventional technique of representing a flow of a plurality of samples as a flow of data such as a flow diagram, it is difficult for data to communicate as visual information how the samples are integrated, separated, and organized. The present invention allows a user to confirm through a motion video, and thus significantly improves confirmation of traceability of denaturation of a sample.

While the user views a motion video to confirm an experimental protocol on trial as described above, the motion video can be reproduced variably in speed. Detailed confirmation can be achieved by stopping and slowly reproducing the motion video in a step of an experiment that the user desires to carefully watch. Further, a reduced confirmation time can be achieved by reproducing fast-forward a processing step spending several hours, such as culturing cells. Further, a motion video can be reproduced in reverse in order to confirm processing of a portion in which a behavior unexpected by a user is found.

In window 510, the distal end of robot 121 that moves culture container Cn1 from incubator 122 to preprocessing device 123, a portion of incubator 122 that performs “culturing cells,” and a portion of preprocessing device 123 that performs “dispensing a liquid” are included in a rectangular indication Rc1 and thus highlighted. By referring to window 510, an experimental device which executes a processing operation can be confirmed.

In window 530, the automatic switching mode is selected. Window 520 displays a motion video of camera 141 or 142. Window 520 displays robot 121 holding culture container Cn1 ejected from incubator 122.

In window 540, a character string of “2: dispensing liquid” is surrounded by a rectangular indication R2 to emphasize a currently executed processing operation, that is, “dispensing a liquid”. The currently executed processing operation may be highlighted by changing a color of a background of the character string “2: dispensing liquid” or the color of the character string.

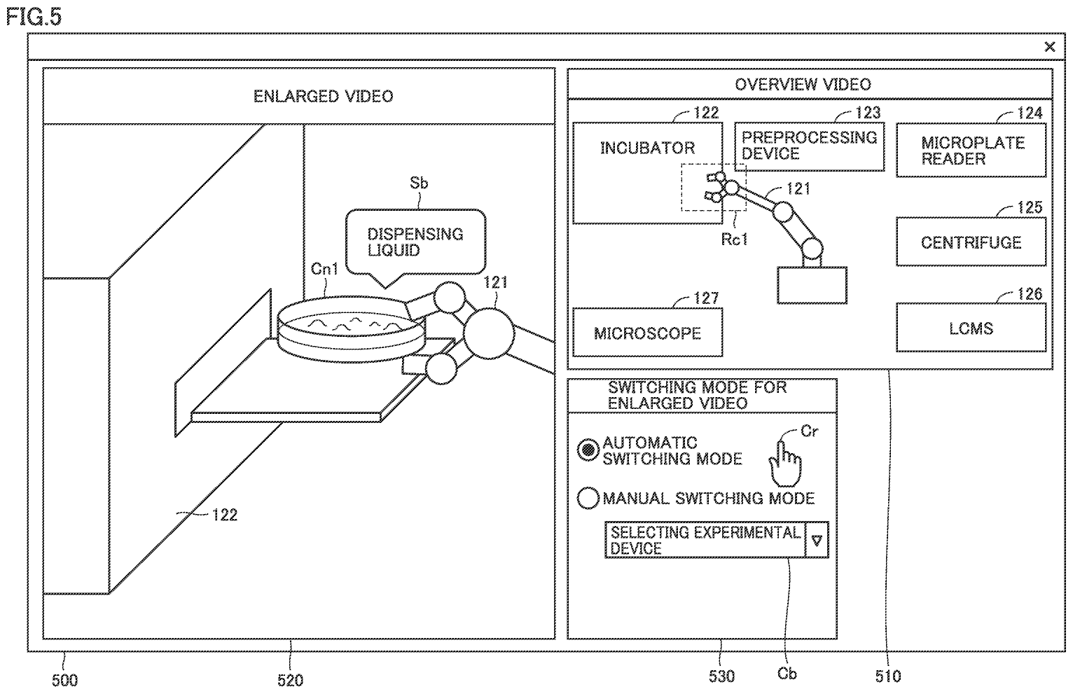

FIG. 5 is a diagram showing another example of the GUI configuration of experimental protocol management program 500 of FIG. 1 displaying a motion video showing experimental protocol p1 of FIG. 3 on trial. The FIG. 5 GUI configuration is the FIG. 4 GUI configuration minus window 540 and plus a balloon Sb added to window 520. The remainder of the FIG. 5 GUI configuration is similar to that of the FIG. 4 GUI configuration, and accordingly, will not be described repeatedly.

As shown in FIG. 5, in window 520, a character string of “dispensing a liquid” representing a currently executed processing operation is indicated in balloon Sb to emphasize the currently executed processing operation. Balloon Sb in window 520 is associated with culture container Cn1 or robot 121 and thus displayed.

For a sucking and discharging operation with a pipette in preprocessing device 123, suction and discharging rates for the pipette in accordance with a property of a sample (or an analyte), a position of the tip of the pipette when suction and discharge are performed, how many times pipetting is required for agitation, etc., are set in the experimental protocol. According to automated experimental system 1, whether a condition for the pipette's suction and discharging operation is appropriately set can be confirmed by confirming how preprocessing device 123 is actually operating while an experimental protocol is on trial (or undergoes a simulated experiment).

For centrifuge 125, a number of revolutions and a rotational speed for centrifugation are set in the experimental protocol. Centrifugation is performed under a condition varying depending on the analyte and the volume of the container for centrifugation. Automated experimental system 1 can provide a user with a motion video showing centrifuge 125 actually providing centrifugation to allow the user to confirm whether the analyte is separated as expected by the user.

For transporting a sample by robot 121, when robot 121 transports container Cn2 after the centrifugation, it is necessary to prevent container Cn2 from being agitated. Automated experimental system 1 allows confirmation of whether a sample is also kept separated in container Cn2 while container Cn2 is transported. Further, it can be confirmed whether agitation is caused in container Cn2 by an impact caused when robot 121 holds container Cn2 or an impact caused when container Cn2 is placed at a target location.

Automated experimental system 1 allows confirmation of a state of culture container Cn1 with cells, microorganisms, or the like contained therein when the culture container is removed from incubator 122 and transported to another device, or how culture container Cn1 is handled in the device to which culture container Cn1 is transported. For example, it can be confirmed how long and to what environment the cells or microorganisms contained in culture container Cn1 are exposed outside incubator 122, or whether a reagent irrelevant to the experiment, a soiled pipette tip or the like does not pass over culture container Cn1 having a lid removed, etc.

A purpose of the simulated experiment is to confirm appropriateness of an experimental condition set in an experimental protocol, and accordingly, it is unnecessary to conduct the simulated experiment with a reagent that is used in an actual experiment. Accordingly, in the simulated experiment, colored water or the like can be used as an alternative to the reagent to reduce a cost required for the simulated experiment. Furthermore, when the alternative to the reagent is used, a waiting time set in the experimental protocol for example to wait for the reagent to react can be dispensed with. Accordingly in the simulated experiment the waiting time can be set to be omitted to reduce a period of time required for the simulated experiment.

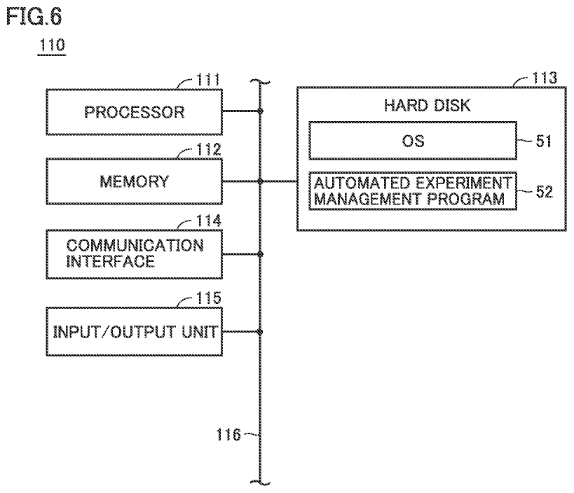

FIG. 6 is a block diagram showing an example of a hardware configuration of controller 110 of FIG. 1. As shown in FIG. 6, controller 110 includes a processor 111, a memory 112 and a hard disk 113 as a storage unit, a communication interface 114 as a communication unit, and an input/output unit 115. These components are communicably interconnected via a bus 116.

Hard disk 113 is a non-volatile storage device. Hard disk 113 stores, for example, an OS program 51 and an automated experiment management program 52. In addition to the data in FIG. 6, for example, settings and outputs of various applications are stored in hard disk 113. Memory 112 is a volatile storage device and includes a dynamic random access memory (DRAM) for example.

Processor 111 includes a CPU (Central Processing Unit). Processor 111 reads a program stored in hard disk 113 into memory 112 and executes the program to implement various functions of controller 110. For example, processor 111 executing automated experiment management program 52 controls a plurality of experiment devices 120 based on an experimental protocol received from terminal device 400. Further, processor 111 executing automated experiment management program 52 sends motion videos captured by cameras 140 to 147 to terminal device 400. Processor 111 is connected to network NW via communication interface 114.

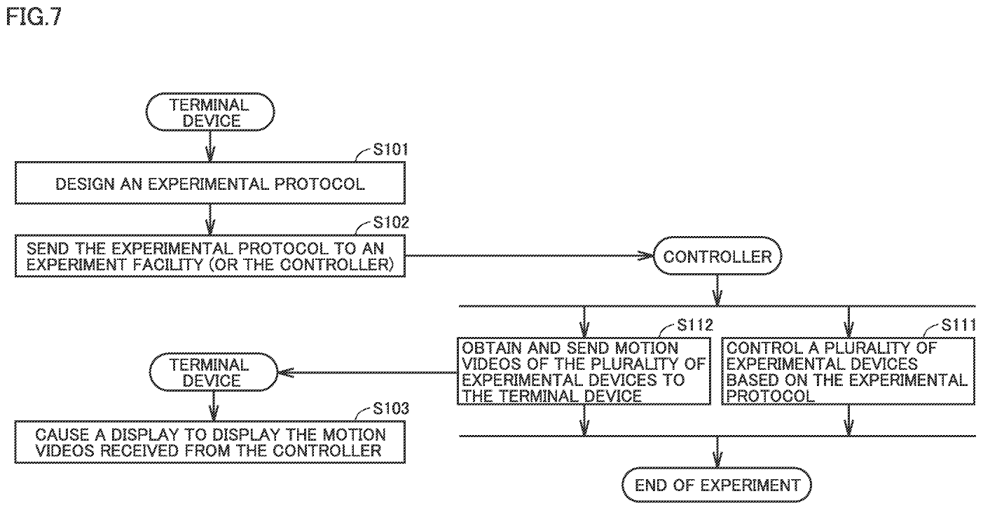

FIG. 7 is a flowchart of an example of a flow of processing executed in automated experimental system 1 of FIG. 1. Hereinafter, a step is simply referred to as S. As shown in FIG. 7, terminal device 400 designs an experimental protocol in S101, and proceeds to S102. In step S102, terminal device 400 sends the experimental protocol of step S101 to controller 110 of experimental facility 100. Controller 110 receives the experimental protocol from terminal device 400, and controls the plurality of experimental devices 120 based on the experimental protocol in S111.

Furthermore, in parallel with execution of the experimental protocol, in step S112, controller 110 obtains motion videos of the plurality of experimental devices 120 from cameras 140 to 147 and also records as additional reproduction data each step of the experimental protocol and a time or a frame number at or for which the processing operation in the step in the motion videos is performed, and the controller sends the motion videos and the additional reproduction data to terminal device 400. Terminal device 400 receives the motion videos from controller 110 and displays them on display 431 via experimental protocol management program 500. Based on the additional reproduction data, terminal device 400 uses the time or frame number of each step of the experimental protocol to associate the motion videos with the step and thus display the motion videos on display 431. The user of terminal device 400 can easily confirm each step of the experimental protocol corresponding to each timing of the motion videos of the plurality of experimental devices 120.

Thus, the system and method of the first embodiment allow confirmation of whether an experimental protocol executed by a plurality of experimental devices is executed as expected.

### Second Embodiment

In the first embodiment has been described a system and method for causing a terminal device to display motion videos of a plurality of experimental devices that actually operate based on an experimental protocol. In a second embodiment will be described an apparatus and a method using a plurality of experimental devices designed in a virtual space to simulate execution of an experimental protocol. A configuration according to the second embodiment allows confirmation of whether an experimental protocol is executed as expected, similarly as described in the first embodiment, and furthermore, can dispense with a plurality of experimental devices, reagents, articles, and the like necessary for an actual experiment and thus reduce a cost required for trial of the experimental protocol more than the first embodiment can.

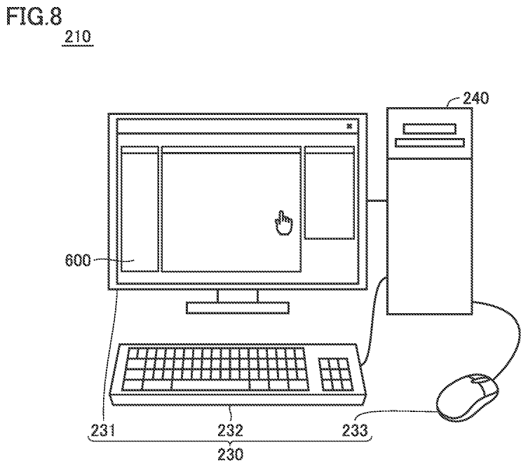

FIG. 8 is a block diagram showing a configuration of an information processing device 210 according to the second embodiment. As shown in FIG. 8, information processing device 210 includes an input/output unit 230 and a computer 240. Input/output unit 230 includes a display 231 (a display unit), a keyboard 232, and a mouse 233. Display 231, keyboard 232, and mouse 233 are connected to computer 240. Display 231 displays a GUI of an experimental protocol simulation program 600. Keyboard 232 and mouse 233 receive a GUI operation done by a user to experimental protocol simulation program 600. That is, the user performs a desired GUI operation to experimental protocol simulation program 600 by operating keyboard 232 or mouse 233 while referring to an indication on display 231.

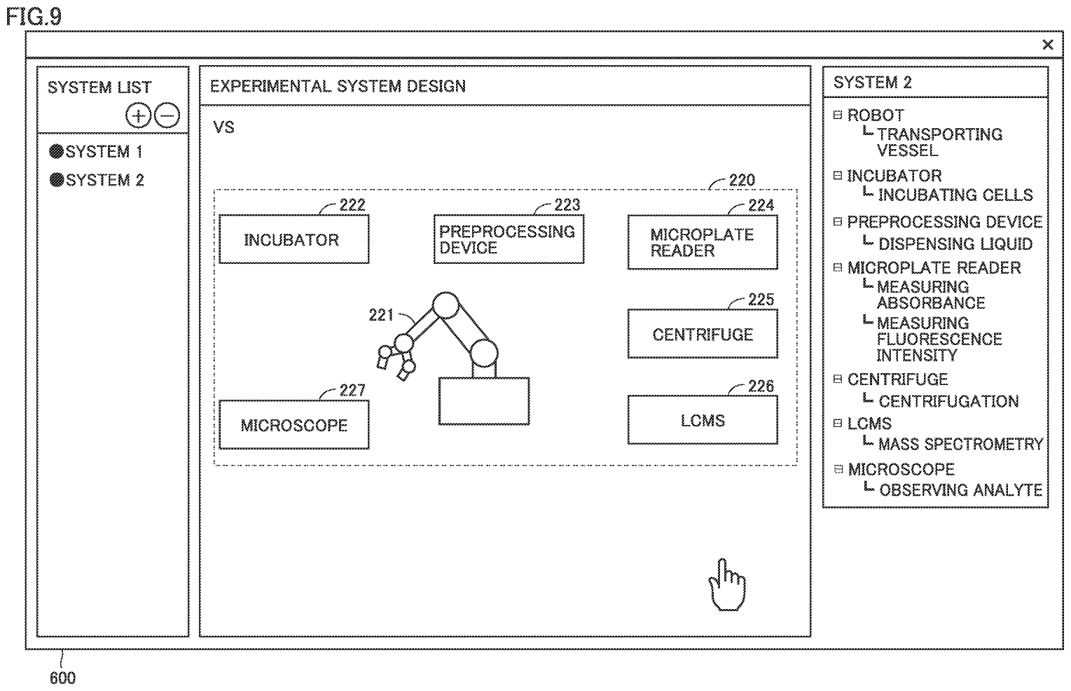

FIG. 9 is a diagram showing a plurality of experimental devices 220 designed in a virtual space VS by experimental protocol simulation program 600 of FIG. 8. As shown in FIG. 9, the plurality of experimental devices 220 includes a robot 221, an incubator 222, a preprocessing device 223, a microplate reader 224, a centrifuge 225, an LCMS 226, and a microscope 227. Robot 221, incubator 222, preprocessing device 223, microplate reader 224, centrifuge 225, LCMS 226, and microscope 227 are similar in function to the FIG. 1 robot 121, incubator 122, preprocessing device 123, microplate reader 124, centrifuge 125, LCMS 126, and microscope 127, respectively. Experimental protocol simulation program 600 can design a plurality of experimental devices for each of a plurality of systems.

Experimental protocol simulation program 600 can design an experimental protocol in a manner similar to the FIG. 3 experimental protocol management program 500 for controlling a plurality of experimental devices designed in virtual space VS. Experimental protocol simulation program 600 can display in a manner similar to the FIG. 4 experimental protocol management program 500 motion videos of the plurality of experimental devices operating in virtual space VS based on the experimental protocol.

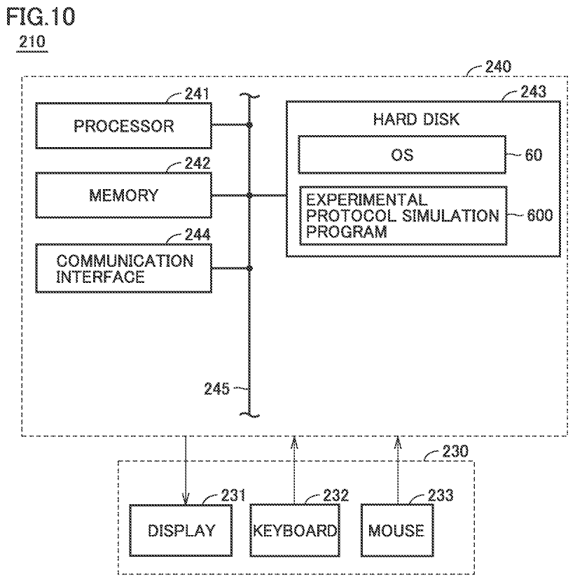

FIG. 10 is a block diagram showing a hardware configuration of information processing device 210 shown in FIG. 8. As shown in FIG. 10, computer 240 includes a processor 241 (a control unit), a memory 242 and a hard disk 243 as storage units, and a communication interface 244. These components are communicably interconnected via a bus 245.

Hard disk 243 is a non-volatile storage device. Hard disk 243 stores, for example, an OS program 60 and experimental protocol simulation program 600. In addition to the data in FIG. 10, for example, settings and outputs of various applications are stored in hard disk 243. Memory 242 is a volatile storage device and includes a dynamic random access memory (DRAM) for example.

Processor 241 includes a central processing unit (CPU). Processor 241 reads a program stored in hard disk 243 into memory 242 and executes the program. When experimental protocol simulation program 600 is executed by processor 241, an experimental protocol is automatically executed by the plurality of experimental devices 220. Processor 241 is connected to a network via communication interface 244.

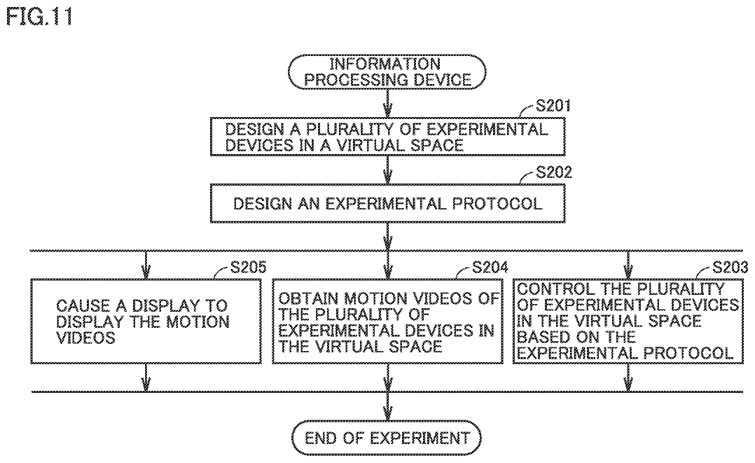

FIG. 11 is a flowchart showing an example of a flow of a simulated process of an experimental protocol performed by computer 240 of FIG. 8. As shown in FIG. 11, computer 240 designs a plurality of experimental devices in a virtual space in S201, and proceeds to S202. Computer 240 designs an experimental protocol in S202 and proceeds to S203 and S204. In step S203, computer 240 controls the plurality of experimental devices 220 in virtual space VS based on the experimental protocol designed in step S202. In parallel with execution of the experimental protocol, computer 240 in S204 obtains (or generates) motion videos of the plurality of experimental devices 220 in virtual space VS, and in S205 causes display 231 to display the motion videos via experimental protocol simulation program 600.

Thus, the system and method of the second embodiment allow confirmation of whether an experimental protocol executed by a plurality of experimental devices is executed as expected, and can also reduce a cost required for trial of the experimental protocol more than the first embodiment can.

### Aspects

It will be understood by those skilled in the art that the exemplary embodiments described above are specific examples of the following aspects:

(Clause 1) According to one aspect, a method comprises the steps of: controlling a plurality of experimental devices based on an experimental protocol in which an order of processing operations is defined; obtaining a motion video such that processing of an analyte in a first experimental device and transportation of the analyte from the first experimental device to a second experimental device can be viewed in a synchronized manner through the motion video, the first and second experimental devices belonging to the plurality of experimental devices; and displaying the motion video.

The method according to clause 1 allows a motion video to be displayed such that processing of an analyte in a first experimental device and transportation of the analyte from the first experimental device to a second experimental device can be viewed in a synchronized manner through the motion video, the first and second experimental devices belonging to the plurality of experimental devices, to allow confirmation of whether an experimental protocol executed by a plurality of experimental devices is executed as expected.

(Clause 2) The method according to clause 1, wherein obtaining the motion video includes storing the motion video.

The method according to clause 2 allows a user to confirm the stored motion video when the user desires to do so.

(Clause 3) The method according to clause 2, wherein storing the motion video includes storing the experimental protocol and the motion video in association with each other.

The method according to clause 3 helps a user to identify and reproduce a motion video desired by the user from a plurality of motion videos for confirming a stored protocol.

(Clause 4) The method according to clause 2 or 3, wherein displaying the motion video includes designating a motion video to be reproduced from the stored motion video, and includes reproducing the motion video when the motion video is designated.

The method according to clause 4 allows a user to confirm the stored motion video by designating reproduction thereof.

(Clause 5) The method according to any one of clauses 1 to 4, wherein displaying the motion video includes changing a speed of reproducing the motion video.

The method according to clause 5 allows detailed confirmation to be achieved by stopping and slowly reproducing a motion video in a step of an experiment that the user desires to carefully watch. Further, a reduced confirmation time can be achieved by reproducing fast-forward a processing step spending several hours, such as culturing cells.

(Clause 6) The method according to any one of clauses 1 to 5, wherein displaying the motion video includes reproducing the motion video in reverse.

The method according to clause 6 allows confirmation of processing of a portion in which a behavior unexpected by a user is found.

(Clause 7) The method according to any one of clauses 1 to 6, further comprising: recording each step of the experimental protocol and a time or a frame number in the motion video, a processing operation in the step being executed at the time and for the frame number; and using the time or the frame number to associate the motion video with the step and causing a terminal device to display the motion video.

The method according to clause 7 helps a user to confirm each step of an experimental protocol corresponding to each timing of motion videos of the plurality of experimental devices 120.

(Clause 8) The method according to any one of clauses 1 to 7, wherein the processing operations include a first processing operation and a second processing operation following the first processing operation. The plurality of experimental devices include a first experimental device to execute the first processing operation and a second experimental device to execute the second processing operation. The motion video includes a video in which an analyte subjected to the first processing operation is moved from the first experimental device to the second experimental device.

The method according to clause 8 allows confirmation of whether an analyte is smoothly passed between two consecutive processing operations in an experimental protocol.

(Clause 9) The method according to any one of clauses 1 to 8, further comprising sending the experimental protocol from a terminal device to a controller to control the plurality of experimental devices. Obtaining the motion video sends the motion video to the terminal device.

The method according to clause 9 allows an experimental protocol to be designed in a terminal device remote from a plurality of experimental devices, and allows confirmation at the terminal device of whether the experimental protocol is executed, as expected.

(Clause 10) The method according to any one of clauses 1 to 8, wherein the plurality of experimental devices are designed in a virtual space.

The method according to clause 10 can dispense with a plurality of experimental devices, reagents, articles, and the like necessary for an actual experiment and thus reduce a cost required for trial of an experimental protocol.

(Clause 11) The method according to any one of clauses 1 to 10, wherein obtaining the motion video includes obtaining a first motion video including the plurality of experimental devices and a plurality of second motion videos respectively including the plurality of experimental devices. In displaying the motion video, the first motion video and a specific motion video of the plurality of second motion videos are displayed in a juxtaposed manner, the specific motion video including at least one specific experimental device.

The method according to clause 11 allows juxtaposed first and specific motion videos to be viewed together so that a general state of the plurality of experimental devices controlled based on the experimental protocol and a specific state of a processing operation being executed can be collectively grasped.

(Clause 12) The method according to clause 11, wherein the at least one specific experimental device included in the first motion video is highlighted in displaying the motion video.

The method according to clause 12 allows confirmation of an experimental device that is currently executing a processing operation.

(Clause 13) The method according to clause 11 or 12, wherein, of the processing operations, the processing operation executed by the at least one specific experimental device is highlighted in displaying the motion video.

The method according to clause 13 allows confirmation of a currently executed processing operation.

(Clause 14) According to one aspect, a system comprises a plurality of experimental devices, a controller, at least one imaging device, and a terminal device. The controller controls the plurality of experimental devices based on an experimental protocol in which an order of processing operations is defined. At least one imaging device obtains a motion video such that processing of an analyte in a first experimental device and transportation of the analyte from the first experimental device to a second experimental device can be viewed in a synchronized manner through the motion video, the first and second experimental devices belonging to the plurality of experimental devices. The terminal device displays the motion video.

The system according to clause 14 allows a motion video to be displayed such that processing of an analyte in a first experimental device and transportation of the analyte from the first experimental device to a second experimental device can be viewed in a synchronized manner through the motion video, the first and second experimental devices belonging to the plurality of experimental devices, to allow confirmation of whether an experimental protocol executed by a plurality of experimental devices is executed as expected.

(Clause 15) According to one aspect, an apparatus comprises a storage unit, a display unit, and a control unit. The storage unit stores a simulation program. The control unit executes the simulation program to control a plurality of experimental devices, based on an experimental protocol in which an order of processing operations is defined, the plurality of experimental devices being designed in a virtual space, and to cause the display unit to display a motion video such that processing of an analyte in a first experimental device and transportation of the analyte from the first experimental device to a second experimental device can be viewed in a synchronized manner through the motion video, the first and second experimental devices belonging to the plurality of experimental devices.

The apparatus according to clause 15 allows a motion video to be displayed such that processing of an analyte in a first experimental device and transportation of the analyte from the first experimental device to a second experimental device can be viewed in a synchronized manner through the motion video, the first and second experimental devices belonging to the plurality of experimental devices, to allow confirmation of whether an experimental protocol executed by a plurality of experimental devices is executed as expected.

It is to be noted that, regarding the above-described first embodiment and exemplary variation, the configurations described in the embodiment, including combinations which are not mentioned in the specification, are intended to be combined, as appropriate, within a scope in which no disadvantage or contradiction occurs.

It should be understood that the presently disclosed embodiments are illustrative and non-restrictive in any respect. The scope of the present invention is defined by the terms of the claims, rather than the above description, and is intended to include any modifications within the meaning and scope equivalent to the terms of the claims.

### REFERENCE SIGNS LIST

1 automated experimental system, 52 automated experiment management program, 100 experimental facility, 110 controller, 111, 241, 421 processor, 112, 242, 422 memory, 113, 243, 423 hard disk, 114, 244, 424 communication interface, 115, 230, 430 input/output unit, 116, 245, 440 bus, 121, 221 robot, 122, 222 incubator, 123, 223 preprocessing device, 124, 224 microplate reader, 125, 225 centrifuge, 127, 227 microscope, 140-147 camera, 210 information processing device, 231, 431 display, 232, 432 keyboard, 233 mouse, 240 computer, 400 terminal device, 433 touch pad, 500 experimental protocol management program, 510, 520, 530, 540 window, 600 experimental protocol simulation program, Cn1 culture container, Cn2, Cn3 container, NW network, R2, Rc1 rectangular indication, VS virtual space, p1 experimental protocol.

1. A method comprising:
controlling a plurality of experimental devices based on an experimental protocol in which an order of processing operations is defined, to conduct a simulated experiment;
obtaining a motion video such that processing of an analyte in a first experimental device and transportation of the analyte from the first experimental device to a second experimental device can be viewed in a synchronized manner through the motion video, the first and second experimental devices belonging to the plurality of experimental devices; and
displaying the motion video,
the simulated experiment being conducted with an alternative to a reagent specified in the experimental protocol.

2. The method according to claim 1, wherein obtaining the motion video includes storing the motion video.

3. The method according to claim 2, wherein storing the motion video includes storing the experimental protocol and the motion video in association with each other.

4. The method according to claim 2, wherein displaying the motion video includes designating a motion video to be reproduced from the stored motion video, and includes reproducing the motion video when the motion video is designated.

5. The method according to claim 1, wherein displaying the motion video includes changing a speed of reproducing the motion video.

6. The method according to claim 1, wherein displaying the motion video includes reproducing the motion video in reverse.

7. The method according to claim 1, further comprising:
recording each step of the experimental protocol and a time or a frame number in the motion video, a processing operation in the step being executed at the time and for the frame number; and
using the time or the frame number to associate the motion video with the step and causing a terminal device to display the motion video.

8. The method according to claim 1, wherein
the processing operations include a first processing operation and a second processing operation following the first processing operation,
the plurality of experimental devices include a first experimental device to execute the first processing operation and a second experimental device to execute the second processing operation, and
the motion video includes a video in which an analyte subjected to the first processing operation is moved from the first experimental device to the second experimental device.

9. The method according to claim 1, further comprising sending the experimental protocol from a terminal device to a controller to control the plurality of experimental devices, wherein obtaining the motion video sends the motion video to the terminal device.

10. The method according to claim 1, wherein the plurality of experimental devices are designed in a virtual space.

11. The method according to claim 1, wherein
obtaining the motion video includes obtaining a first motion video including the plurality of experimental devices and a plurality of second motion videos respectively including the plurality of experimental devices, and
in displaying the motion video, the first motion video and a specific motion video of the plurality of second motion videos are displayed in a juxtaposed manner, the specific motion video including the first experimental device.

12. The method according to claim 11, wherein the first experimental device included in the first motion video is highlighted in displaying the motion video.

13. The method according to claim 11, wherein, of the processing operations, the processing operation executed by the first experimental device is highlighted in displaying the motion video.

14. A system comprising:
a plurality of experimental devices;
a controller that controls the plurality of experimental devices based on an experimental protocol in which an order of processing operations is defined, to conduct a simulated experiment;
at least one imaging device that obtains a motion video such that processing of an analyte in a first experimental device and transportation of the analyte from the first experimental device to a second experimental device can be viewed in a synchronized manner through the motion video, the first and second experimental devices belonging to the plurality of experimental devices; and
a terminal device that displays the motion video,
the simulated experiment being conducted with an alternative to a reagent specified in the experimental protocol.

15. (canceled)

16. A method comprising:
controlling a plurality of experimental devices based on an experimental protocol in which an order of processing operations is defined;
obtaining a motion video such that processing of an analyte in a first experimental device and transportation of the analyte from the first experimental device to a second experimental device can be viewed in a synchronized manner through the motion video, the first and second experimental devices belonging to the plurality of experimental devices; and
displaying the motion video,
displaying the motion video including displaying a video of an overview of the plurality of experimental devices and a video of an enlarged view of a process of the transportation in real time in a juxtaposed manner.

17. An apparatus comprising:
a storage unit that stores a simulation program;
a display unit; and
a control unit that executes the simulation program to perform the method according to claim 14 to cause the display unit to display the motion video.
